(19) United States
(12) Patent Application Publication
(10) Pub. No.: US 2003/0178577 A1
(43) Pub. Date: Sep. 25, 2003

(54) Apparatus for measuring fluorescence

(76) Inventor: Petri Aronkyto, Raisio (FI)

Correspondence Address: KUBOVCIK & KUBOVCIK, SUITE 710, 900 17TH STREET NW, WASHINGTON, DC, 20006

(21) Appl. No.: 10/338,051

(22) Filed: Jan. 8, 2003

(30) Foreign Application Priority Data
Jan. 8, 2002 (FI) 20020018

(51) Int. Cl. G01N 21/64

(52) U.S. Cl. 250/458.1

(57) ABSTRACT

An apparatus for measuring fluorescence from a sample, where an excitation system includes optical fibers or optical fiber bundles each starting from two or more lasers and mingled so as to form a single optical fiber bundle. Excitation light beams can be passed separately or simultaneously directly via this optical fiber bundle or via a common optical fiber bundle to a sample.

### SUBJECT OF THE INVENTION

The present invention relates to an apparatus for measuring fluorescence from an array of samples, which apparatus comprises an excitation system having a light guide, such as an optical fiber or optical fiber bundle, for passing an excitation light produced by a light source, such as a laser, to a sample.

### PRIOR ART

A known technique for measuring fluorescence is to use in a fluorometer a laser or lamp as a source of excitation light, which is directed, e.g., via an optical fiber to a sample. The amount of light given by lamps is usually small, whereas the laser has the drawback that its light consists of only one wavelength.

As fluorometric measurements involve the use of various markers and each marker is excited by a different wavelength, light beams having several different wavelengths are needed. And since it is often desirable to measure several different markers with the same device, the measuring device must have a plurality of lasers producing light beams of different wavelengths. For this purpose, fluorometric apparatus have been constructed that are provided with several different lasers and complex mirror systems for them. By using the mirrors, it has been possible to apply to the sample a suitable light appropriate for the measurement in each case. However, because of the mirrors, such measuring devices are complicated and unpractical. A prior-art solution that uses mirrors is disclosed in U.S. Pat. No. 6,042,785.

### OBJECT OF THE INVENTION

An object of the present invention is to achieve an apparatus for measuring fluorescence from an array of samples, which apparatus comprises an excitation system that is substantially more versatile and effective that prior-art devices and that does not have the above-mentioned drawbacks.

### FEATURES OF THE INVENTION

The apparatus of the invention for measuring fluorescence from a sample is characterized in that the apparatus comprises

a stage configured to hold a microplate having an array of sample wells;

a detector;

an emission optical relay structure, wherein the emission optical relay structure directs light emitted from the sample toward the detector; and

an excitation system comprising:

two or more lasers for producing excitation light,

a single fiber or a fiber bundle associated with each laser for receiving the excitation light from the laser,

an optical fiber system that combines the excitation light from the single fibers or the fiber bundles, into a single fiber or fiber bundle; and

an excitation optical relay structure, the excitation light from the said single fiber or fiber bundle toward a sample contained in at least one of the sample wells.

In the apparatus of the invention, in addition to a light guide which is an optical fiber or optical fiber bundle, the excitation system comprises an arrangement for passing the excitation light beams produced by two or more lasers, via said light guide to the sample separately or simultaneously.

In the excitation system, two or more lasers are connected together to form an excitation light source for a fluorometer so that the lasers can be used in a measurement separately or in combination. The light beams produced by the lasers have either the same wavelength or different wavelengths.

### SUMMARY OF THE INVENTION

A preferred embodiment of the apparatus of the invention for measuring fluorescence from a sample is characterized in that the apparatus comprises

an emission optical relay structure, having an emission polarizer, wherein the emission optical relay structure directs the light emitted from the sample through the emission polarizer toward the detector,

an excitation system having an optical fiber system that combines the excitation light beams from multiple lasers, in single fibers or fiber bundles, into a single fiber or fiber bundle; and

an excitation optical relay structure having an excitation polarizer, wherein the excitation optical relay structure directs excitation light from the said single fiber or fiber bundle through the excitation polarizer toward a sample contained in at least one of the sample wells.

Each laser used in the apparatus is connected separately to a light guide which is an individual optical fiber or optical fiber bundle.

Another preferred embodiment of the apparatus of the invention is characterized in that

the excitation system comprises optical fibers or optical fiber bundles for passing the light beams emitted by two or more lasers to a sample, and that

separate fibers or fiber bundles starting from different light sources are combined to form a single common bundle, through which the light beams produced by the light sources can be passed to the sample.

The fibers starting from individual lasers are combined into a bundle, the end of the optical fiber bundle forming an excitation light source.

A third preferred embodiment of the apparatus of the invention is characterized in that, in the excitation system, optical fiber bundles starting from two or more lasers are combined to form a single common optical fiber bundle, through which the light beams emitted by the light sources can be passed to the sample.

If the optical fiber bundle is formed as a mixed bundle, then the end of the fiber bundle thus obtained constitutes an effective excitation light source that is not position-sensitive.

A fourth preferred embodiment of the apparatus of the invention is characterized in that the excitation system comprises optical fibers or optical fiber bundles starting from two or more lasers, the light guide ends opposite to the lasers being connected to the end of an optical fiber or optical fiber bundle, through which the light beams from the light sources can be directed to a sample.

A fifth preferred embodiment of the apparatus of the invention is characterized in that

in the excitation system, optical fiber bundles start from two or more lasers, and that

in the optical fiber bundles, the optical fiber ends opposite to the lasers are combined into a single common optical fiber bundle, which is connected to the end of an optical fiber or optical fiber bundle, through which the light beams from the light sources can be directed to the sample.

Yet another preferred embodiment of the apparatus of the invention is characterized in that, in the excitation system, the intermediate optical fiber bundle formed by the ends opposite to the lasers of optical fibers or optical fiber bundles starting from two or more lasers, has a diameter smaller than that of the single optical fiber or single optical fiber bundle to which the end of this intermediate bundle can be connected.

Even when several lasers are to be combined, the light passed through them is accurately focused because each optical fiber or optical fiber bundle may be very thin. Therefore, the end of the mixed bundle is still sufficiently thin even when small sample wells, e.g., 1536-well sample plates, are to be measured. For example, if three lasers are to be connected so that the end of the mixed bundle, i.e., the excitation light source, has a diameter of 1 mm, then the light of each laser must be applied to a fiber bundle having a diameter of about 0.58 mm.

The excitation wavelength, i.e., the laser that is active at each instant, is selected by switching the lasers on and off. The pulsed light to be used as an excitation light source is produced by firing the lasers electronically. Another alternative is to use mechanical shutters between the lasers and the fibers or anywhere in the optical light path formed by the fibers. The use of shutters is advantageous in the case of lasers that need to be kept continuously on to ensure their stable operation.

It is also possible to use several lasers of the same color simultaneously, thus creating a light source that has the desired color and a particularly high power while still being accurately focusable. The high excitation intensity obtained using several lasers is especially usable in fluorescence polarization measurements because polarization filters reduce the intensity of the light. The invention is therefore well applicable for use in plate fluorometers.

### BRIEF DESCRIPTION OF DRAWINGS

In the following, the invention will be described in detail by the aid of examples with reference to the attached drawings, wherein

FIG. 1 presents a schematic diagram of a prior-art device in which the excitation light is passed via a light guide.

FIG. 2a presents a schematic diagram of a device according to the invention.

FIG. 2b presents a schematic diagram of another device according to the invention.

FIG. 3 presents a schematic diagram visualizing a method of connecting a laser to a light guide.

FIG. 4 corresponds to FIG. 3 and illustrates another embodiment of the method of connecting a laser.

FIG. 5 presents a schematic diagram illustrating the connecting of light guides to each other.

FIG. 6 presents a diagram showing a detail of the connection of light guides according to one embodiment.

FIG. 7 corresponds to FIG. 6 and shows a detail of the connection of light guides according to another embodiment.

FIG. 8 corresponds to FIG. 6 and shows a detail of the connection of light guides according to a third embodiment.

FIG. 9 presents a cross-section taken along line A-A in FIG. 8.

FIG. 10 corresponds to FIG. 6 and shows a detail of the connection of light guides according to a fourth embodiment.

### DETAILED DESCRIPTION OF PREFERRED EMBODIMENTS

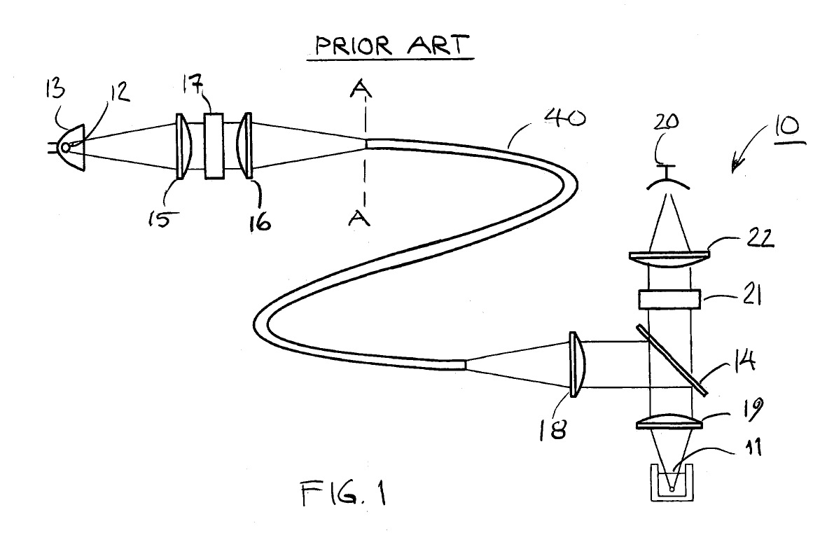

FIG. 1 presents a prior-art measuring device 10 for measuring fluorescence from a sample, in which device the excitation light is passed to the sample 11 to be measured from a lamp 12 provided with a reflector 13 via a light guide 40, such as an optical fiber bundle, and a mirror 14. The mirror 14 is either semi-transparent or dichroic. From the lamp 12, the excitation light is converged by means of lenses 15 and 16 into a beam narrow enough to fit the optical fiber bundle 40. Placed between the lenses 15 and 16 is a filter 17, by means of which the excitation light wavelength can be selected. The excitation light output from the optical fiber bundle 40 is focused on the sample 11 by means of lenses 18 and 19. The light emitted by the sample 11 is detected by a detector 20, to which the emission light is passed via an emission filter 21 and a lens 22.

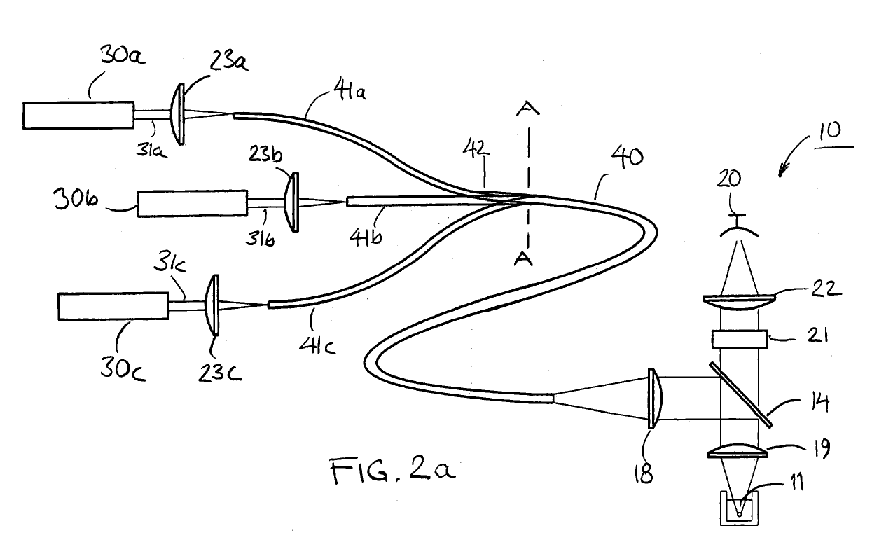

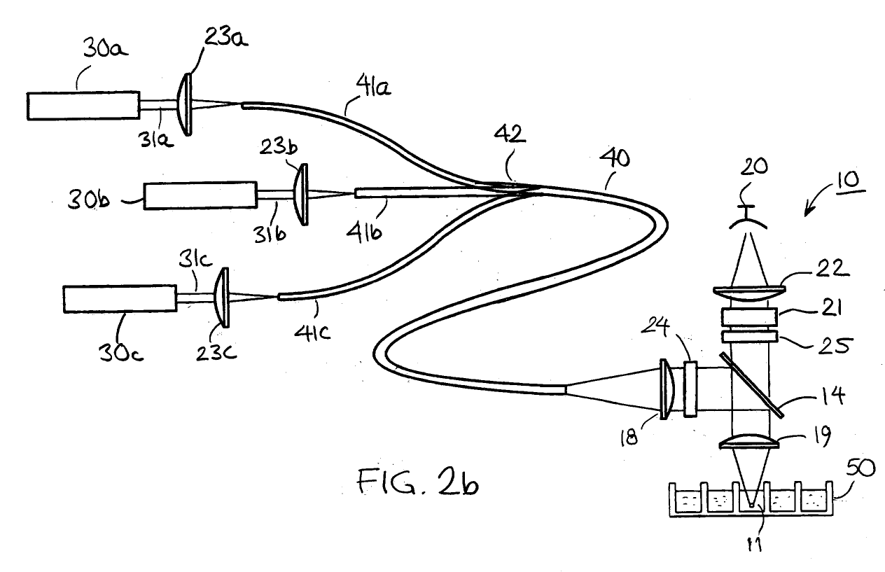

FIG. 2a presents a measuring device 10 for measuring fluorescence from a sample corresponding to the device in FIG. 1, implemented according to the present invention. The measuring device 10 comprises three lasers 30a, 30b and 30c, and the excitation light produced by them is directed to the sample 11 via light guides, i.e., optical fibers or optical fiber bundles 41a, 41b, 41c and 40. As light guides 41a-41c are narrow in diameter, each laser is provided with a lens 23a, 23b, 23c, and these converge the light beams 31a, 31b and 31c produced by the lasers 30a-30c into narrower beams that fit the light guides 41a-41c.

The light beams produced by the lasers 30a-30c may have either the same or different wavelengths. The lasers 30a-30c can be used individually, i.e., each one separately, or two or more lasers can be used simultaneously, depending on the embodiment required. In some measurements, a combination of two or more lasers of different colors may be used. In some measurements, it is again advantageous to use two or more lasers of the same color because in this case a particularly high excitation light intensity is achieved. The measurement may also be performed by first using the lasers separately and then two or more lasers together.

In the device for measuring fluorescence presented in FIG. 2a, light guides 41a, 41b and 41c constitute light guide branches which, at a point 42 at a suitable distance from the lasers 30a-30c, are integrated into a single combined light guide 40. If the combined light guide 40 and the light guide branches 41a-41c are optical fiber bundles, then the combined optical fiber bundle 40 is formed by combining the optical fibers of the optical fiber bundles 41a-41c into a single randomly mixed fiber cluster. Since the combined optical fiber bundle 40 contains randomly mixed optical fibers coming from all the lasers 30a-30c, the light emanating from any one of the lasers 30a-30c is no longer position-sensitive. The excitation light transmitted through the combined optical fiber bundle 40 is passed in the conventional manner to a lens 18 and via a semi-transparent or dichroic mirror to the sample 11. The measurement of the sample is performed in a known manner by using a detector 20, to which the emission light is passed via an emission filter 21 and a lens 22.

In the measuring device 10 in FIG. 2a, the lasers 30a-30c replace the lamp 12 and filters 17 used in the measuring device in FIG. 1, which were used to select the excitation light wavelength. When lasers are used, the excitation light wavelength needed in the measurement is obtained by selecting the laser of the lasers 30a-30c whose light is of the most appropriate wavelength, i.e., color. In this case, each measurement is carried out using only one laser alone. As the optical fibers in the sub-bundles 41a, 41b and 41c of optical fibers coming from the lasers 30a, 30b and 30c are intermingled, the light produced by each individual laser comes out of the combined optical fiber bundle 40 across the entire fiber bundle width without being position-sensitive.

As the excitation light is to be pulsed light, it is also necessary to be able to fire the lasers 30a, 30b and 30c electronically in a pulsed fashion. If the lasers 30a, 30b and 30c are of a type, such as gas lasers, that necessitates continuous operation in order to give stable performance, then the optical light path can be provided with an interrupter of mechanical or electronic nature placed at any point in the path. A suitable point for the interrupter in the optical light path is, e.g., between the laser 30 and the lens 23 or between the lens 23 and the optical fiber 41.

In the measuring device 10 for measuring fluorescence in FIG. 2a, the combination of the lasers 30a, 30b and 30c generating excitation light can also be constructed as a separate component comprising the lasers 30a-30c, their lenses 23a, 23b and 23c and the combined sub-bundles 41a, 41b and 41c of optical fibers up to point A-A. In this case, this separate component can be mounted in place of the excitation light part in FIG. 1 so that it replaces the lamp 12 provided with a reflector 13, the lenses 15 and 16 and the filter 17 up to the corresponding point A-A. This is of essential importance when the excitation light part of an existing measuring device 10 is to be replaced with a component according to the invention, which is more efficient than prior-art devices.

FIG. 2b presents another measuring device 10 for fluorescence palarization measurements. In the excitation optical relay structure of the measuring device 10 there is an excitation polarizer 24 and in the emission optical relay structure there is an emission polarizer 25.

In the device of FIG. 2b the lasers 30a-30c are preferably of different color and the light beams 31a-31c are directed through optical structure for focusing, such as lenses 23a-23c, to the optical fibers 41a-41c. From the combined light guide bundle 40 the excitation light is directed through the excitation optical relay structure and excitation polarizer 24 to the sample 11 in the sample well of the microplate 50.

From the sample well the emission light is directed through the emission optical relay structure, such as lens 19, emission polarizer 25, emission filter 21 and another lens 22 to the detector 20.

Essential for the device in FIG. 2b is that the light from the lasers 30a-30c is focused to the optical fibers 41a-41c and from the combined light guide bundle 40 the excitation light is focused in the excitation optical relay structure to the sample 11 in the sample well of the microplate 50. Correspondingly, the emission light from the sample 11 is focused by the emission optical relay structure to the detector 20.

Relating to the apparatus for measuring fluorescence, FIG. 3 illustrates the connecting of a laser 30 to an individual light guide 41, which consists of a single optical fiber or optical fiber bundle. As the light beam 31 of the laser 30 in this embodiment has a width larger than the diameter of the light guide 41, the light beam 31 of the laser 30 is converged by means of a lens 23 to form a sufficiently narrow beam.

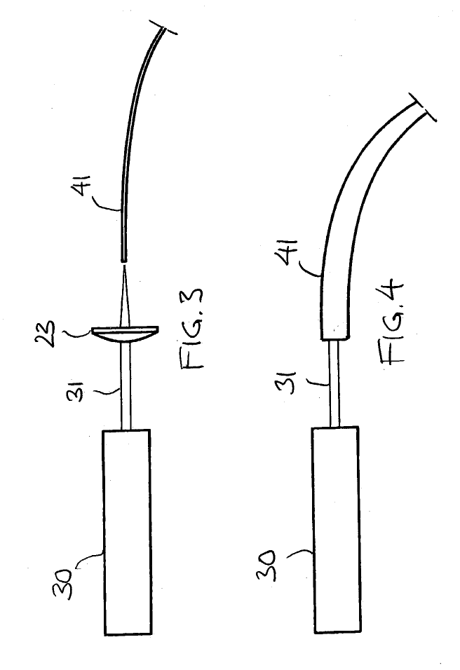

In the embodiment of the method of connecting the laser 30 and the light guide 41 presented in FIG. 4, the width of the light beam 31 is smaller than the diameter of the light guide 41, i.e., individual optical fiber or optical fiber bundle 41. In this case, the laser 30 can be connected by known means directly to the light guide 41 without a lens.

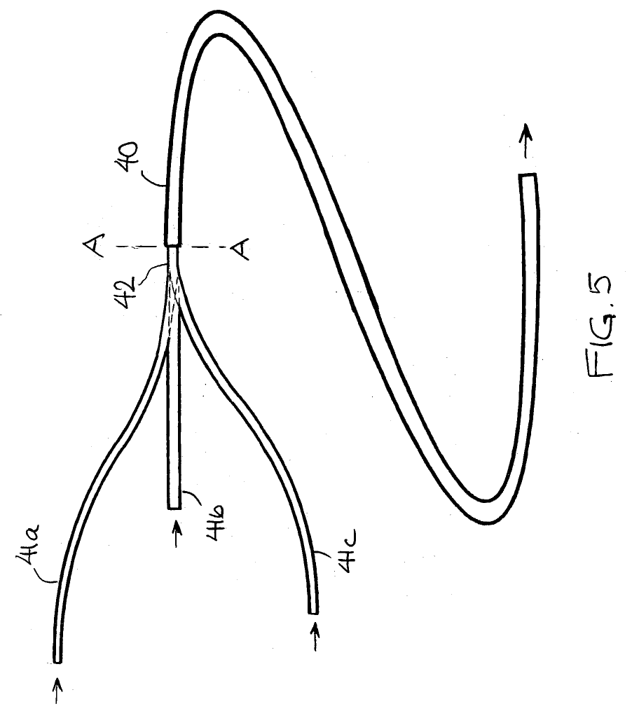

FIG. 5 illustrates a method of connecting the light guide branches 41a-41c coming from the lasers to a light guide 40. The light guide branches 41a-41c and the light guide 40 are preferably light fiber bundles. The essential point about this connection method is that the diameter of the optical fiber bundle 40 is larger than that of the connecting part 42 of the sub-bundles 41a, 41b and 41c coming from the lasers. The junction between the connecting part 42 and the optical fiber bundle 40 may be implemented as a fixed junction, but it may also be a detachable junction. In this case, the detachable part formed by the optical fiber bundles 41a-41c is comprised in the component according to the invention designed to replace the earlier excitation system of an existing measuring device.

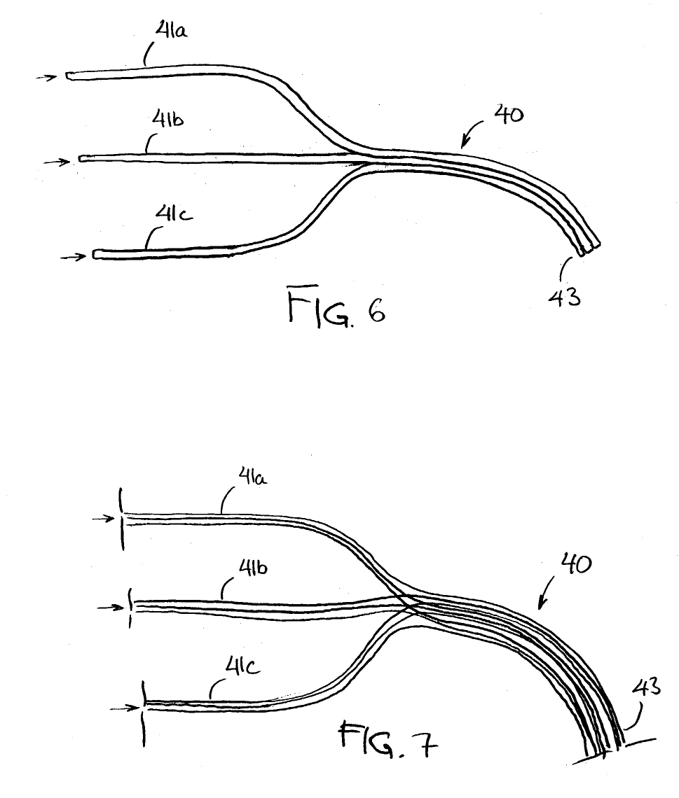

FIG. 6 illustrates a method of assembling together light guides 41a, 41b and 41c which are optical fibers coming from three lasers. In this embodiment, the individual optical fibers 41a-41c are combined into an optical fiber bundle 40 by setting the separate optical fibers 41a-41c side by side so that they are in contact with each other. Such an assembly method is not as advantageous because the optical fibers 41a-41c coming from different lasers are clearly at different positions at the end 43 of the optical fiber bundle 40. Therefore, an optical fiber bundle 40 like this is “position-sensitive”, which means that the optical fibers 41a-41c coming from different lasers apply the excitation light to different points of the sample.

FIG. 7 illustrates another method of assembling the light guides 41a-41c together. In this embodiment, the light guides 41a-41c are optical fiber bundles. They are combined in such a way that, in the combined optical fiber bundle 40, the optical fibers of different optical fiber bundles 41a-41c are randomly mingled among each other. In this case, the optical fibers 41a-41c coming from different lasers are scattered randomly at the end 43 of the optical fiber bundle 40. Such an optical fiber bundle 40 is not position-sensitive because each one of the optical fiber bundles 41a-41c coming from different lasers applies the excitation light uniformly to the same area of the sample.

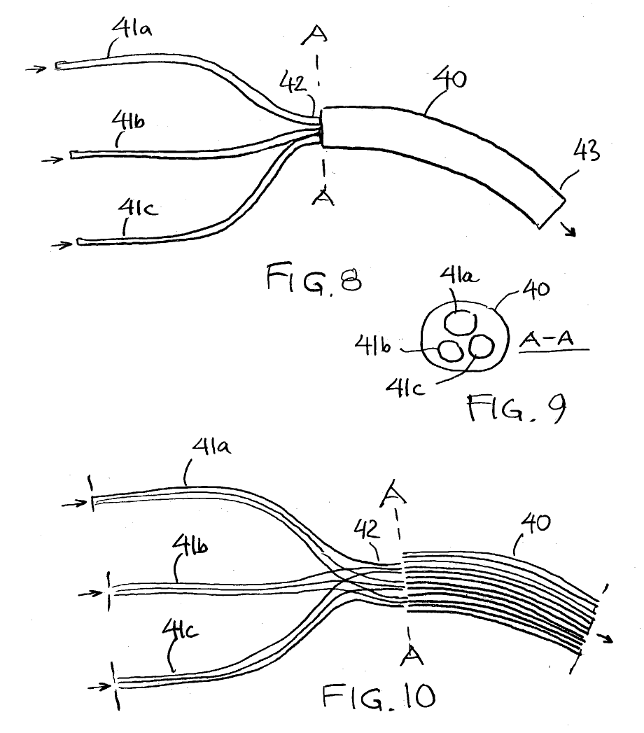

FIG. 8 illustrates a solution for connecting three optical fibers 41a-41c to a single common optical fiber 40. In this embodiment, the individual optical fibers 41a-41c are assembled together at point 42. The ends of the separate fibers 41a-41c are placed side by side at the junction 42 and pressed into contact with the end of the larger light guide 40. The essential point about the junction 42 is that the common optical fiber 40 should have a diameter larger than the diameter of the bundle formed by the separate optical fibers 41a-41c.

The cross-sectional view in FIG. 9 shows the junction between the individual optical fibers 41a, 41b and 41c coming from three lasers and the common optical fiber 40. The figure shows that the ends of all these separate optical fibers 41a-41c fit in the area of the cross-section of the common optical fiber 40. Although in the embodiments in FIGS. 8 and 9 the optical fibers 41a-41c coming from different lasers are located at different points of the cross-section of the optical fiber 40 at the junction 42, the light beams emanating from the optical fibers 41a-41c are mixed in the common optical fiber 40.

FIG. 10 illustrates the connection of optical fibers in an embodiment where all the optical fibers 41a-41c and 40 are optical fiber bundles. Optical fiber bundles 41a-41c are assembled together at point 42 in such manner that the optical fibers of all optical fiber bundles 41a-41c are randomly mingled among each other. In this case, the optical fibers coming from different lasers are evenly scattered at the junction 42. When the end of the optical fiber bundle consisting of optical fibers thus scattered is set against the end of a larger-diameter optical fiber bundle 40, the light emanating separately from each laser is evenly distributed over the cross-sectional area of the common optical fiber bundle 40 and the light rays emanating from different lasers are still likewise evenly distributed at the opposite end 43 of the optical fiber bundle 40. Consequently, the light of each laser can be evenly distributed over the same area of the sample. Such an optical fiber arrangement is not position-sensitive, which is an advantage in view of achieving measurement results of uniform quality.

Additional Remarks

It is obvious to the person skilled in the art that different embodiments of the invention are may be varied within the scope of the claims presented below.

### LIST OF REFERENCE NUMERALS

10 measuring device

11 sample

12 lamp

13 reflector

14 mirror

15 lens

16 lens

17 filter

18 lens

19 lens

20 detector

21 emission filter

22 lens

23 lens

24 excitation polarizer

25 emission polarizer

30 laser

31 light beam

40 light guide (combined)

41 light guide branch

42 junction of light guides (assembled bundle)

43 end of light guide (opposite to laser)

50 microplate

1. An apparatus for measuring fluorescence from a sample, the apparatus comprising:
a stage configured to hold a microplate having an array of sample wells;
a detector for detecting the fluorescence;
an emission optical relay structure, wherein the emission optical relay structure directs light emitted from the sample toward the detector; and
an excitation system comprising:
two or more lasers for producing excitation light,
a first fiber or a first fiber bundle associated with each laser for receiving the excitation light from the laser,
an optical fiber system that combines the excitation light from the first fibers or first fiber bundles, into a single optical fiber or single optical fiber bundle; and
an excitation optical relay structure, wherein the excitation optical relay structure directs the excitation light from the said single optical fiber or single optical fiber bundle toward the sample contained in at least one of the sample wells.

2. An apparatus according to claim 1, further comprising
an emission optical relay structure, having an emission polarizer, wherein the emission optical relay structure directs light emitted from the sample through the emission polarizer toward the detector; and wherein
the excitation optical relay structure includes an excitation polarizer, wherein the excitation optical relay structure directs excitation light from the said single fiber or fiber bundle through the excitation polarizer toward the sample contained in at least one of the sample wells.

3. An apparatus according to claim 1 or 2, wherein the first optical fibers or optical fiber bundles are combined into the single optical fiber bundle.

4. An apparatus according to claim 1 or 2, wherein in the excitation system, first optical fiber bundles starting from two or more lasers, are combined to form the single optical fiber bundle.

5. An apparatus according to claim 1 or 2, wherein the ends of the first optical fibers opposite to the light sources are connected to the end of the single optical fiber.

6. An apparatus according to claim 1 or 2, wherein
in the excitation system, first optical fiber bundles start from each of the two or more lasers, and
ends of the first optical fiber bundles opposite to the light sources are connected to an end of the single optical fiber bundle.

7. An apparatus according to claim 5, wherein in the excitation system, an intermediate optical fiber bundle is formed by ends of the first optical fibers and has a diameter smaller than that of the single optical fiber to which it is connected.

8. An apparatus according to claim 5, wherein in the excitation system, an intermediate optical fiber bundle is formed by ends of the first optical fiber bundles and has a diameter smaller than that of the single optical fiber bundle to which it is connected.
